(19) United States
(12) Patent Application Publication
(10) Pub. No.: US 2018/0073471 A1
(43) Pub. Date: Mar. 15, 2018

(54) ALUMINUM PLATE AND EGR COOLER INCLUDING THE SAME

(71) Applicant: HYUNDAI MOTOR COMPANY, Seoul (KR)

(72) Inventors: Dong Young LEE, Goyang-si (KR); Seok HA, Seoul (KR); Sung Il YOON, Seoul (KR); Tae Ho JEONG, Yongin-si (KR)

(21) Appl. No.: 15/374,465

(22) Filed: Dec. 9, 2016

(30) Foreign Application Priority Data
Sep. 9, 2016 (KR) 10-2016-0116717

(51) Int. Cl. F02M 26/32

(52) U.S. Cl. CPC F02M 26/32

(57) ABSTRACT

An aluminum plate includes a tube having a first surface, through which a coolant flows, and a second surface, through which exhaust gas flows, and configured to exchange heat using a temperature difference between the coolant and the exhaust gas. The tube is formed of an aluminum-based material, and includes Mg and Ti.

### CROSS-REFERENCE TO RELATED APPLICATION

This application claims the benefit of priority to Korean Patent Application No. 10-2016-0116717, filed in the Korean Intellectual Property Office on Sep. 9, 2016, the entire content of which is incorporated herein by reference.

### TECHNICAL FIELD

The present disclosure relates to an exhaust gas recirculation (EGR) cooler, which recirculates exhaust gas from an exhaust line to an intake line for decreasing a content of nitrogen oxide and a granular material generated in the exhaust gas, and cools the recirculated exhaust gas, and an aluminum plate used therein.

### BACKGROUND

Recently, as environment problems, such as global warming, have emerged, regulations on automobile exhaust gas have become stricter, and particularly, a strict standard is applied to the emission quantity of exhaust gas of an automobile.

Particularly, under the EURO-6, in a case of a diesel engine for a car, the quantity of NOx generated needs to decrease to a level of 80 mg/km, and in this respect, the automobile-related companies have adopted new technologies, such as exhaust gas recirculation (EGR), lean NOx trap (LNT), and selective catalytic reduction (SCR).

An exhaust gas recirculation (EGR) device includes a high pressure exhaust gas recirculation (HP-EGR) device, which recirculates exhaust gas and mixes the recirculated exhaust gas with compressed air, and a low pressure exhaust gas recirculation (LP-EGR) device, which recirculates exhaust gas at a rear end of a diesel particle filter (DPF) and mixes the recirculated exhaust gas with air at a front end of the turbo charger.

In this case, in order to cool the recirculated exhaust gas, an EGR cooler is disposed in an exhaust gas recirculation line, and the EGR cooler is made of a stainless material having high corrosion resistivity to a high temperature state and condensate water.

However, the EGR cooler made of the stainless material is heavy, has low heat transmission efficiency, and has a poor molding property, and its components are expensive. Accordingly, research on the EGR cooler, which has high heat transmission efficiency, has an excellent molding property, and is made of aluminum, and of which components are relatively cheap, has been conducted.

Typically, A1100 that is based on pure aluminum (A1xxx) and A3003 that is based on aluminum-manganese (A3xxx) are used in a pin and a tube of a heat exchanger, which is a cooler, and a temperature of recirculated exhaust gas is about 550° C.

Further, corrosive ions, such as Cl⁻, SO₄²⁻, and NO₃⁻, exist as a component of condensate water, so that the aluminum-based pin or tube may be damaged in a high temperature environment and a corrosive environment. In this respect, research on an aluminum sheet having high strength and high corrosion resistivity is conducted.

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to provide an aluminum plate, which maintains strength and has high corrosion resistivity in an environment, in which corrosive ions, such as Cl⁻, SO₄²⁻, and NO₃⁻, exist as the components of condensate water, and a temperature of recirculated exhaust gas is about 550° C., and an EGR cooler including the same.

An exemplary embodiment of the present disclosure provides an aluminum plate including a tube having a first surface, through which a coolant flows, and a second surface, through which exhaust gas flows, and configured to exchange heat using a temperature difference between the coolant and the exhaust gas. The tube is formed of an aluminum-based material, and includes Mg and Ti.

The tube may include a core layer, and a cladding layer formed on a surface layer of the core layer, and the core layer may be formed of an aluminum-based material, and may include Mg and Ti.

The core layer may include Cu, Si, Fe, Zn, Mg, Mn, Ti, and Al.

The core layer may include 0.4 to 0.64 wt % of Cu, 0.6 to 0.84 wt % of Si, 0.4 to 0.6 wt % of Fe, a maximum of 0.05 wt % of Zn, 0.3 to 0.4 wt % of Mg, 0.1 to 0.2 wt % of Ti, and the remainder of Al, based on a total weight of the core layer.

Another exemplary embodiment of the present disclosure provides an exhaust gas recirculation (EGR) cooler, which cools exhaust gas recirculated from an exhaust line to an intake line of an engine, the EGR cooler including: a housing provided with an internal space; tubes disposed in the internal space of the housing and spaced apart by a predetermined interval; and a pin disposed at an internal side of the tube, and being in contact with an internal surface of the tube. A coolant flows between the housing and the tube, and the exhaust gas flows in the internal side of the tube, and the tube is formed of an aluminum-based material, and includes Mg and Ti.

The tube may include a core layer, and a cladding layer formed on a surface layer of the core layer, and the core layer may be formed of an aluminum-based material, and may include Mg and Ti.

The core layer may include Cu, Si, Fe, Zn, Mg, Mn, Ti, and Al.

The core layer may include 0.4 to 0.64 wt % of Cu, a maximum of 0.84 wt % of Si, a maximum of 0.6 wt % of Fe, a maximum of 0.05 wt % of Zn, a maximum of 0.4 wt % of Mg, 0.1 to 0.2 wt % of Ti, and the remainder of Al, based on a total weight of the core layer.

According to the exemplary embodiments of the present disclosure, the aluminum plate has higher strength and improved corrosion resistivity at a high temperature and in an environment, in which corrosive ions exist, than those of the general aluminum plate of A3003.

Further, the EGR cooler using the aluminum plate may decrease its weight by the material characteristic of the aluminum, improve heat exchange efficiency, and have a relatively high strength and high corrosive resistive characteristic to improve marketability and durability.

### BRIEF DESCRIPTION OF THE DRAWINGS

FIG. 1 is a cross-sectional view of one side of an EGR cooler according to an exemplary embodiment of the present disclosure.

FIG. 2 is a schematic cross-sectional view of a plate used in the EGR cooler according to the exemplary embodiment of the present disclosure.

FIG. 3 is a table representing ingredients of the plate used in the EGR cooler according to the exemplary embodiment of the present disclosure.

FIGS. 4A to 4C are tables representing a conditions and results for a comparison of the plate used in the EGR cooler according to the exemplary embodiment of the present disclosure and a comparative example.

FIGS. 5A and 5B are pictures illustrating an experiment result of the plate used in the EGR cooler according to the exemplary embodiment of the present disclosure and a comparative example.

FIG. 6 is a schematic diagram of an engine including the EGR cooler related to the present disclosure.

### DETAILED DESCRIPTION OF THE EMBODIMENTS

Hereinafter, an exemplary embodiment of the present disclosure will be described in detail with reference to the accompanying drawings.

In addition, the size and thickness of each configuration shown in the drawings are arbitrarily shown for understanding and ease of description, but the present disclosure is not limited thereto, and the thickness of layers, films, panels, regions, etc., are exaggerated for clarity.

A part irrelevant to the description will be omitted to clearly describe the exemplary embodiment of the present disclosure, and the same elements will be designated by the same reference numerals throughout the specification.

In the following description, dividing names of components into first, second and the like is to divide the names because the names of the components are the same as each other and an order thereof is not particularly limited.

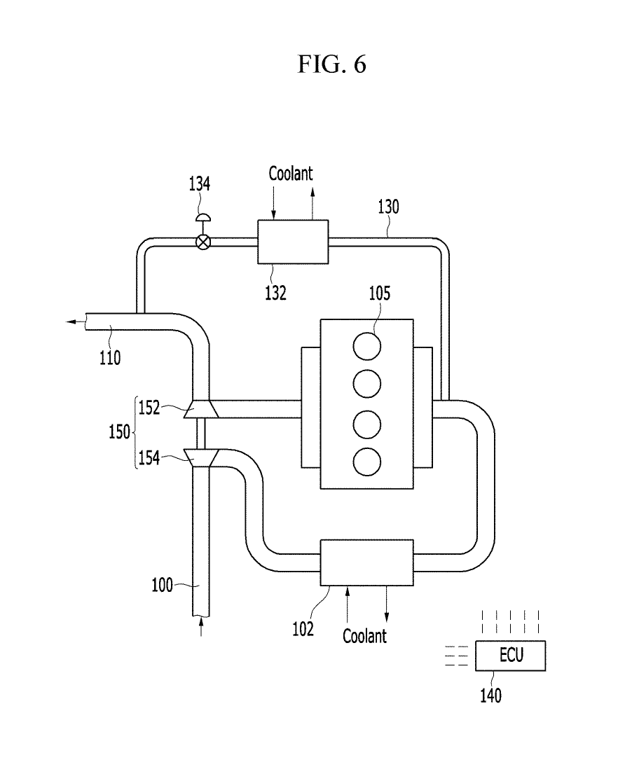

FIG. 6 is a schematic diagram of an engine including the EGR cooler related to the present disclosure.

Referring to FIG. 6, an engine including an exhaust gas recirculation (EGR) cooler includes an intake line 100, a turbo charger 150 including a turbine 152 and a compressor 154, an intercooler 102, a combustion chamber 105, an exhaust line 110, an EGR line 130, an EGR valve 134, an EGR cooler 132, and a controller 140.

Intake air supplied through the intake line 100 is compressed by the compressor 154 of the turbo charger 150, is cooled via the intercooler 102, and is supplied to the combustion chamber 105 of the engine.

An injector (not illustrated) injects fuel into the combustion chamber 105, the injected fuel and the intake air are combusted, the combusted exhaust gas is discharged to the outside through the exhaust line 110, and the turbine 152 of the turbo charger 150 is rotated by the exhaust gas to rotate the compressor 154.

A part of the exhaust gas flowing in the exhaust line 110 is recirculated to the intake line 100 through the EGR line 130, and the EGR valve 134 and the EGR cooler 132 are disposed in the EGR line 130.

The controller 140 controls the amount that the EGR valve 134 is opened according to an operation condition, and controls the quantity of fuel injected to the combustion chamber 105. Further, the EGR cooler 132 cools the exhaust gas recirculated along the EGR line 130.

The intercooler 102 and the EGR cooler 132 are disposed to cool the intake air and the exhaust gas by using a coolant, respectively. A part, which is not described in the present specification, is referred to the related art.

In the present exemplary embodiment, a temperature of the exhaust gas passing through the EGR cooler 132 reaches about 550° C., and condensate water is generated according to a decrease of a temperature of the exhaust gas by the EGR cooler 132, and the ingredients of the condensate water include corrosive ions, such as Cl⁻, SO₄²⁻, and NO₃⁻.

Accordingly, strength is high and corrosion resistivity of the aluminum plate is improved at a high temperature and an environment, in which the corrosive ions exist, compared to a general aluminum plate of A3003 by improving a material characteristic of aluminum used in a tube 210 and a pin 215 of the EGR cooler 132.

Further, the EGR cooler 132 using the aluminum plate may decrease its weight by the material characteristic of the aluminum, improve heat exchange efficiency, and have a relatively high strength and high corrosion resistive characteristic to improve marketability and durability.

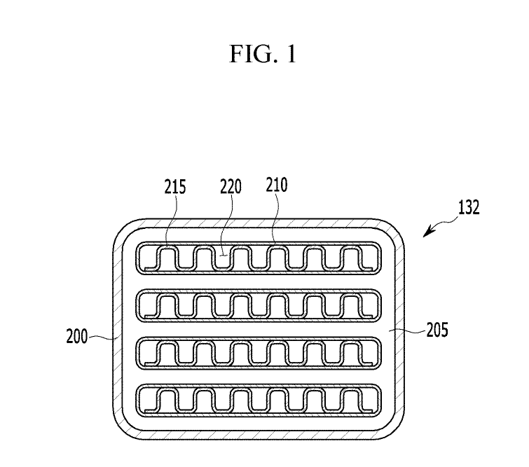

FIG. 1 is a cross-sectional view of one side of the EGR cooler according to an exemplary embodiment of the present disclosure, and referring to FIG. 1, the EGR cooler includes a housing 200, a tube 210, and a pin 215.

A space is formed inside the housing 200, and the tubes 210 are disposed inside the housing 200 from an upper portion to a lower portion of the housing 200 with a predetermined interval, and the pin 215 having a zigzag form is disposed inside the tube 210.

An upper side of the pin 215 is brazed to an upper surface of an internal side of the tube 210, a lower side of the pin 215 is brazed to a lower surface of the internal side of the tube 210, and the pin 215 improves efficiency of heat transfer between the recirculated exhaust gas and the coolant.

A coolant path 205, in which a coolant flows, is formed between an external surface of the tube 210 and the internal surface of the housing 200, an exhaust gas path 220, through which recirculated exhaust gas passes, is formed inside the tube 210, and the recirculated exhaust gas is cooled by the coolant through the pin 215 and the tube 210.

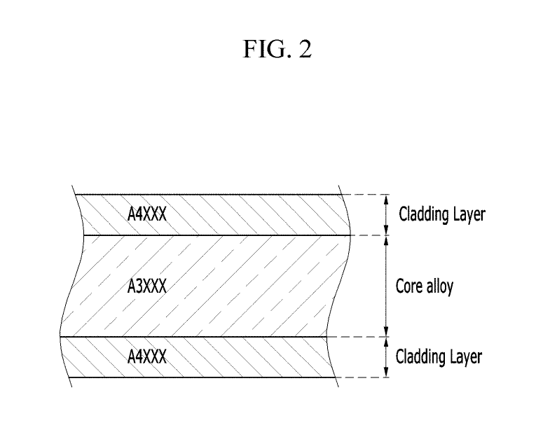

FIG. 2 is a schematic cross-sectional view of a plate used in the EGR cooler according to the present exemplary embodiment.

Referring to FIG. 2, the tube 210 is generally formed of three layers, and includes a core layer at a center thereof, and cladding layers formed on both surfaces of the core layer.

An A3000-based aluminum alloy is used in the core layer, and an A4000-based aluminum alloy is used in the cladding layer.

In the present exemplary embodiment, an age-hardening effect by an extraction of MgSi may be provided by adding a magnesium (Mg) ingredient to the core layer, and general strength of the core layer may be improved by an extraction of Al₁₂(Fe/Mn)₃Si fine dispersoid and Al₂Cu by increasing the contents of Si and Cu.

Further, it is possible to improve corrosion resistivity by adding an ingredient of Ti, and the addition of the ingredient of Ti to the aluminum alloy may change a corrosion progress from a localized corrosion to a lateral corrosion, thereby effectively restricting through-corrosion.

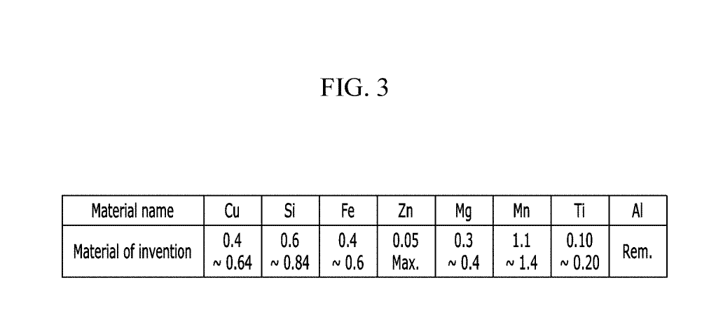

FIG. 3 is a table representing ingredients of the plate used in the EGR cooler according to the present exemplary embodiment.

Referring to FIG. 3, the core layer of the pin 215 or the tube 210 used in the EGR cooler 132 includes Cu, Si, Fe, Zn, Mg, Mn, Ti, and Al, and a mass ratio of each element is 0.4 to 0.64 wt % of Cu, 0.6 to 0.84 wt % of Si, 0.4 to 0.6 wt % of Fe, a maximum of 0.05 wt % of Zn, 0.3 to 0.4 wt % of Mg, 1.1 to 1.4 wt % of Mn, 0.1 to 0.2 wt % of Ti, and the remainder of Al, based on a total weight of the core layer.

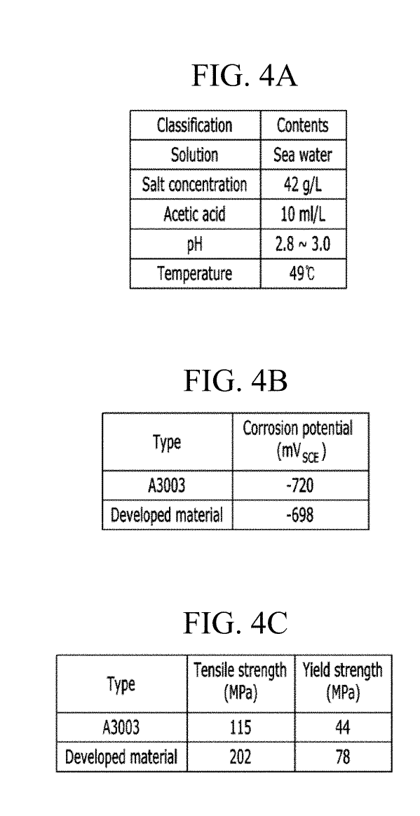

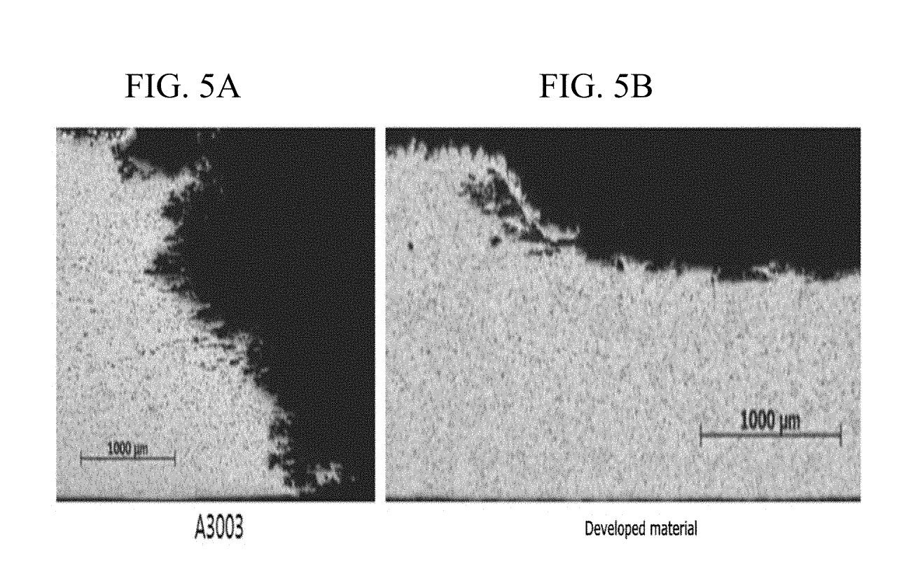

FIGS. 4A to 4C are tables representing a characteristic of the plate used in the EGR cooler according to exemplary embodiments of the present disclosure, and FIGS. 5A and 5B are pictures illustrating an experiment result of the plate used in the EGR cooler according to exemplary embodiments of the present disclosure.

FIG. 4A represents a sea water acetic acid test (SWAAT) method, in which acetic acid is added to artificial sea water and pH is adjusted to a predetermined value (2.8 to 3), and a specimen is exposed at a specified temperature for a specified time.

In a case where an aluminum plate is exposed to a corrosive environment according to the SWAAT method, referring to FIG. 5A, it can be seen that corrosion of the existing material A3003 is considerably progressed, and referring to FIG. 5B, it is represented that corrosion of the material according to the present disclosure is relatively little progressed.

Referring back to FIG. 4B, corrosion potential of A3003 is −720, and corrosion potential of the developed material is −698, so that it can be seen that the development material has improved resistivity to the corrosion.

Further, referring to FIG. 4C, A3003 has tensile strength of 115 MPa and yield strength of 44 MPa, and the developed material has tensile strength of 202 MPa and yield strength of 78 MPa, so that it can be seen that both tensile strength and yield strength of the developed material are improved.

While this disclosure has been described in connection with what is presently considered to be practical exemplary embodiments, it is to be understood that the disclosure is not limited to the disclosed embodiments. On the contrary, it is intended to cover various modifications and equivalent arrangements included within the spirit and scope of the appended claims.

What is claimed is:

1. An aluminum plate, comprising;
a tube having a first surface, through which a coolant flows, and a second surface, through which exhaust gas flows, and configured to exchange heat using a temperature difference between the coolant and the exhaust gas,
wherein the tube is formed of an aluminum-based material, and includes Mg and Ti.

2. The aluminum plate of claim 1, wherein:
the tube includes
a core layer, and a cladding layer formed on a surface layer of the core layer, and
the core layer is formed of an aluminum-based material, and includes Mg and Ti.

3. The aluminum plate of claim 2, wherein:
the core layer includes at least one selected from Cu, Si, Fe, Zn, Mg, Mn, Ti, and Al.

4. The aluminum plate of claim 2, wherein:
the core layer includes Cu, Si, Fe, Zn, Mg, Mn, Ti, and Al.

5. The aluminum plate of claim 4, wherein:
the core layer includes 0.4 to 0.64 wt % of Cu,
0.6 to 0.84 wt % of Si,
0.4 to 0.6 wt % of Fe,
a maximum of 0.05 wt % of Zn,
0.3 to 0.4 wt % of Mg,
1.1 to 1.4 wt % of Mn,
0.1 to 0.2 wt % of Ti, and
the remainder of Al, based on a total weight of the core layer.

6. An exhaust gas recirculation (EGR) cooler, which cools exhaust gas recirculated from an exhaust line to an intake line of an engine, the EGR cooler comprising:
a housing provided with an internal space;
tubes disposed in the internal space of the housing and spaced apart by a predetermined interval; and
a pin disposed at an internal side of the tube, and being in contact with an internal surface of the tube,
wherein a coolant flows between the housing and the tube, and the exhaust gas flows in the internal side of the tube, and
the tube is formed of an aluminum-based material, and includes Mg and Ti.

7. The EGR cooler of claim 6, wherein:
the tube includes
a core layer, and a cladding layer formed on a surface layer of the core layer, and
the core layer is formed of an aluminum-based material, and includes Mg and Ti.

8. The EGR cooler of claim 7, wherein:
the core layer includes at least one selected from Cu, Si, Fe, Zn, Mg, Mn, Ti, and Al.

9. The EGR cooler of claim 7, wherein:
the core layer includes Cu, Si, Fe, Zn, Mg, Mn, Ti, and Al.

10. The EGR cooler of claim 9, wherein:
the core layer includes 0.4 to 0.64 wt % of Cu,
a maximum of 0.84 wt % of Si,
a maximum of 0.6 wt % of Fe,
a maximum of 0.05 wt % of Zn,
a maximum of 0.4 wt % of Mg,
0.1 to 0.2 wt % of Ti, and
the remainder of Al, based on a total weight of the core layer.
